(19) United States
(12) Patent Application Publication
(10) Pub. No.: US 2004/0034690 A1
(43) Pub. Date: Feb. 19, 2004

(54) System and method for selectively forwarding text messages to users by voice telephone

(76) Inventor: Kennen R. Schmitz, Dallas, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/464,428

(22) Filed: Jun. 18, 2003

Related U.S. Application Data
(60) Provisional application No. 60/389,807, filed on Jun. 18, 2002.

(51) Int. Cl. G06F 15/16

(52) U.S. Cl. 709/206

(57) ABSTRACT

In accordance with a preferred embodiment of the invention, text based messages that are received by a user are checked to determine if they meet certain criteria. The criteria is preferably defined or definable by a user. If a text message meets the criteria, it is converted to speech and delivered in a specified manner.

### RELATED APPLICATIONS

This patent application claims the benefit of U.S. Provisional Application No. 60/389,807, entitled, “System and Method for Selectively Forwarding Text Messages to Users by Voice Telephone,” filed on Jun. 18, 2002, the disclosure of which is incorporated herein by reference.

### TECHNICAL FIELD OF THE INVENTION

The present invention relates generally to the field of communications, and more particularly to a system and method for selectively forwarding electronic messages to a user.

### SUMMARY OF THE INVENTION

E-mail and similar forms of electronic message communications are becoming increasingly popular, and are now frequently being used to deliver important and/or time sensitive messages. However, many people do not always have access to E-mail, or do not want to always be checking and/or reading E-mails, especially when they are away from a computer. The invention has as a general objective providing delivery by telephone or other voice communication system of text messages meeting specified criteria.

In accordance with a preferred embodiment of the invention, text based messages that are received by a user are checked to determine if they meet certain criteria. The criteria is preferably defined or definable by a user. If a text message meets the criteria, it is converted to speech and delivered in a specified manner. For example, the user may be called at a specified telephone number, and the message played back; or a specified voice messaging service may be called and the message played to the service. Alternately, in addition to the foregoing, the text message may be forwarded to a voice communication system gateway or voice messaging system that converts it to a voice message for playback or storage and then playback. The invention is particularly advantageous for use in making a telephone call to a user when an important text message is received by the user, and playing the message back to the user.

Furthermore, in accordance with another aspect of a preferred embodiment of the invention, the user is able to specify or indicate which text message server(s) (for example, e-mail servers) are to be checked for new messages, which criteria is to be used for deciding text messages be forwarded, and how the forwarding is to be handled.

In accordance with another aspect of a preferred embodiment of the invention, a user may specify different treatments for a text message, based on specified criteria. For example, a phone call to a first telephone number may be made for messages meeting a first criteria, and to a second telephone number may be made for messages meeting a second criteria.

The foregoing summary is of certain aspects of a preferred or exemplary embodiment of the invention, and is not intended to limit the invention as claimed. Additional aspects, and their advantages, of the embodiment will be apparent from the following detailed description of it, made in reference to the accompanying drawings, in which:

### BRIEF DESCRIPTION OF THE DRAWINGS

FIG. 1 is a flowchart of an exemplary embodiment method for forwarding electronic messages to a user;

FIG. 2 is a top-level diagram of an exemplary system in which an email forwarding system may be used; and

FIG. 3 is a top-level diagram of another exemplary system in which an email forwarding system may be used.

### DETAILED DESCRIPTION OF THE DRAWINGS

Like numbers refer to like elements in the following description.

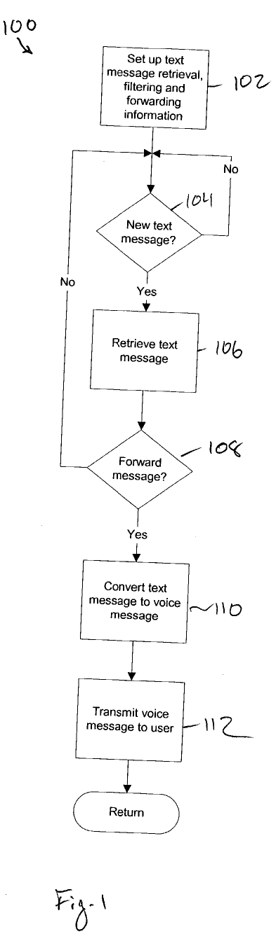

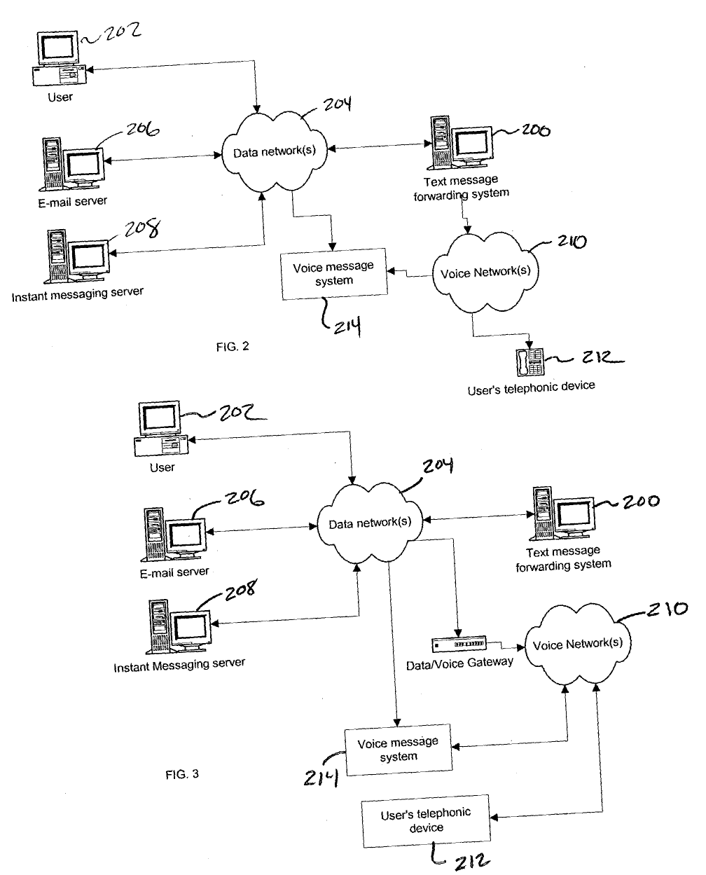

An exemplary embodiment of a method 100 for forwarding text messages, particularly e-mails, to a recipient for playback over a telephone is illustrated at a high level by a flowchart in FIG. 1. The method will be described in reference to examples of networks in FIGS. 2 and 3 that may employ the method. However, it will be appreciated that the method is not limited to the particular examples given, or any particular network configuration. The process executes on text message forwarding system 200. The text message forwarding system is, for example, a computer executing a program or set of programs that implements the method 100. The programs may, however, execute on multiple servers, and these servers may either be at the same physical site or located at different physical sites. Furthermore, the process may on the same server(s) as other processes. The text message mail forwarding system 200 is intended to be representative of any combination of servers and programs that execute method 100.

Step 102 represents optional setup process for a user to specify or set up communication parameters that enable the text message forwarding system to communicate with text based messaging service(s), for example E-mail servers, to be monitored or checked for messages, as well as information for how to handle messages. Information of this type will be referenced as setup information, even if it is not supplied during setup step 102. Some or all of the setup information could be provided by an operator of a text message forwarding system. In a preferred embodiment, the setup information is supplied by a user through use of a Web-based interface, accessible through a data network such as the Internet. With reference to examples of FIGS. 2 and 3, a user accesses, for example, a web site from computer 202 over data network(s) 204 to provide this information and make any changes. Data network(s) 204 are, in the preferred embodiment, a public network, such as the Internet. However, the data networks could also be private networks, whether or not they are Internet Protocol based, or a combination of public and private networks.

One advantage of having a user being able to provide this information is that the user can freely specify any number of different E-mail services and filters for working with text message forwarding system 200, and can change them at will. The services of the text message forwarding system 200 can therefore be offered independently of any E-mail service, and can be used with most such services as long as the E-mail services support standard E-mail protocols. For example, a user may specify one or more E-mail services, represented by E-mail servers 206 and 208. Communications with most E-mail servers currently takes place using the POP3 (Post Office Protocol) or IMAP (Internet Message Access Protocol) protocols, though other protocols, both proprietary and public, could be supported. Thus, typically, the server's URL would be specified (or could be supplied from a database of such information maintained for at least widely used E-mail services), an account name and a password. However, the rest of process 100, described below, could be used, if desired, in conjunction with an E-mail service that a user cannot change. For example, an E-mail service may offer a forwarding service such as described by process 100.

The user preferably specifies during setup step 102 one or filters, or sets of criteria, that will be used to determine which of the text messages are to be handled, and how the messages meeting the criteria are to be handled. Optionally, no criteria or filter can be specified, though the benefit and advantage of selectively forwarding only important messages is lost. Such filtering criteria may include one or more of the addresses or names of sender(s), importance (or status) of the message, the domain of the sender's address, the recipient address (in the event multiple addresses are used by a recipient), keywords in the subject or body of the message, and time of the message. In other words, the criteria may include any value in any field of the text message, any combination thereof, including information in the message header and the server from which the message was retrieved. Furthermore, if desired, the user may specify that electronic messages that meet certain criteria be forwarded to different telephone numbers, or to one or more voice messaging systems.

At step 104, text message forwarding system checks the one or more text message services (e.g. E-mail servers) that are specified in the setup for the user. If there is a new message, it is retrieved at step 106 and checked against the filters at step 108 to determine if it is message that is to be converted to speech or audio and transmitted to the user. The entire message need not be checked. For example, it may be sufficient to at least initially download only header information. If a message does not meet the criteria for forwarding, it may be discarded or some other action taken. Otherwise, at step 110, the text in the message is converted to speech and transmitted to the user at step 112.

Conversion to speech may include some or all of the header information. For example, it may include only the sender name and subject line. However, it may also include the names of other recipients and other information contained in the E-mail. Preferably, it at least includes the body of the message. The conversion step may take place before step 112, or may take place in conjunction with step 112. For example, the conversion may store the speech version of the text message as a file in a compressed or uncompressed standard digital audio format, such as WAV, WMA, MP3 or any other. This file can be stored for playback by the text forwarding system at a later time or forwarded for playback by another system, depending on the method of transmission. Alternately, the conversion can be in real time, as a user or voice messaging system is listening to the audio version of the text message.

Transmission of the converted message to the user can take place in several different ways, with certain ways having advantage over other ways. First, as shown in FIG. 2, the text message forwarding system 200 may forward it directly to voice network(s) 210, which can be the public switched telephone network. To do this, the system may use a modem to dial a telephone number specified in the user's setup information. When the telephone is answered, either by a user using telephone 212 or, perhaps, by a voice message system, such as voice message system 214, the speech or voice version of the message is played. The telephone can be any type of telephone device, i.e. a device that can set up bi-directional or full duplex voice communication.

One benefit of this method of transmission is that a user is notified of an important message through a telephone call. The message then can be immediately played back. The user may be given the option of not hearing the message prior to the message being played back, perhaps after hearing who the sender of the message is. If the user selects not to hear the message, the user may instruct that the message be sent, for example, to a voice messaging system, saved for listening to at some future time, or discarded. Furthermore, if the user is not able to answer the telephone call, and if the user has a voice messaging service, represented by voice message system 214, that is set up for the particular telephone number, the call will automatically be answered by the voice message service. The voice message could then be played back to the voice message system. The voice message service then could notify the user of a waiting message. If desired, the text message forwarding system could permit the user to specify that the voice message not be read to a voice messaging service. Instead, the text message forwarding system could be set up to call a different number, try calling again at some later time, or wait until the user calls in to listen to the message.

As indicated in FIG. 3, the text message forwarding system could also transmit the audio version of the message over data network(s) 204 to a gateway for a voice network, an example of which is represented by gateway 216 for voice network(s) 210. One way of transmitting the voice message would be, for example, a voice over IP (VoIP) call placed through the data networks to the gateway. This would avoid toll charges. Alternately, the audio file for the message could be delivered directly to a voice network, such as a cellular network. The voice network, or some element of the voice network, places a call to the telephone number specified by in the setup file for the user in the text forwarding system and delivered with the audio file, or specified in the user's profile for the voice network, and plays back the audio file to the user (or a voice messaging system) when the call is answered.

Finally, as indicated in FIGS. 2 and 3, the text message forwarding system could transmit the voice message directly to a voice messaging system 214, either in a streaming fashion or as a text file. The voice messaging system would then notify the user of a waiting message.

While the invention has been particularly shown and described by the foregoing detailed description, it will be understood by those skilled in the art that various other changes in form and detail may be made without departing from the spirit and scope of the invention.

What is claimed is:

1. A method for selectively forwarding electronic messages to a user, comprising:
checking for text messages;
determining whether at least one of said text messages meets one or more specified criteria;
if at least one of said text message meets at least one of said one or more specified criteria, converting said at least one text message into an audio message; and
transmitting the audio message to a specified telephone number for playback.

2. The method of claim 1, further comprising retrieving said text messages.

3. The method of claim 1, further comprising playing back said audio message to a user at said specified telephone number.

4. The method of claim 1, further comprising transmitting the audio message to a second specified telephone number.

5. The method of claim 1, wherein said converting said at least one text message comprises converting at least a portion of a header of said at least one text message.

6. The method of claim 1, wherein said converting said at least one text message comprises converting at least a portion of a body of said at least one text message.

7. The method of claim 1, further comprising storing said audio message in a voice messaging system associated with said specificed telephone number.

8. A system for selectively forwarding electronic messages to a user, comprising:
a text message forwarding system operable to:
check for text messages;
determine whether at least one of said text messages meets one or more specified criteria;
if at least one of said text message meets at least one of said one or more specified criteria, convert said at least one text message into an audio message; and
transmit the audio message to a specified telephone number for playback.

9. The system of claim 8, wherein said text message forwarding system is further operable to retrieve said text messages.

10. The system of claim 8, wherein said text message forwarding system is further operable to play back said audio message to a user at said specified telephone number.

11. The system of claim 8, wherein said text message forwarding system is further operable to transmit the audio message to a second specified telephone number.

12. The system of claim 8, wherein said text message forwarding system is further operable to convert at least a portion of a header of said at least one text message.

13. The system of claim 8, wherein said text message forwarding system is further operable to convert at least a portion of a body of said at least one text message.

14. The system of claim 8, further comprising a voice messaging system associated with said specified telephone number for storing said audio message.
